(19) United States
(12) Patent Application Publication
(10) Pub. No.: US 2014/0317310 A1
(43) Pub. Date: Oct. 23, 2014

(54) IMAGE PROCESSING SYSTEM, IMAGE PROCESSING METHOD, AND STORAGE MEDIUM

(71) Applicant: CANON KABUSHIKI KAISHA, TOKYO (JP)

(72) Inventor: Junichi Hiruma, Hidaka-shi (JP)

(73) Assignee: CANON KABUSHIKI KAISHA, TOKYO (JP)

(21) Appl. No.: 14/251,466

(22) Filed: Apr. 11, 2014

(30) Foreign Application Priority Data
Apr. 18, 2013 (JP) 2013-087888

(51) Int. Cl. H04L 12/701

(52) U.S. Cl. CPC H04L 45/00
USPC 709/238

(57) ABSTRACT

An image processing device receives a user ID, adds domain information to the received user ID after a user is successfully authenticated based on the received user ID, sets the domain information and the user ID as a part of path information of a folder to which image data is sent, and transmits the image data to the folder indicated by the path information.

### BACKGROUND

1. Field

Aspects of the present invention generally relate to an image processing system and an image processing method for transmitting image data, and a storage medium.

Description of the Related Art

Until now, it has been known that image data is transmitted in a file from an image processing apparatus such as a multifunction peripheral (MFP). It has also been known that image data is transmitted using a server message block (SMB), for example, as a transmission protocol for file transmission (refer to Japanese Patent Application Laid-Open No. 2011-234126). As another example, it has been known that image data is transmitted using a file transfer protocol (FTP). As still another example, it has been known that image data is transmitted using a distributed authoring and versioning (DAV) protocol for the world wide web (WWW) (Web DAV).

When the file transmission is performed, path information indicating a host name of a file server for managing a folder which stores the image data and a position of the folder, and authentication information (a user name and a password) for accessing the file server are necessary.

When a user transmits the image data from the image processing apparatus in a file, the user who is operating the image processing apparatus may desire to transmit the image data to his/her folder as a destination and to store the image data therein. In this case, there arises a problem that it is troublesome for the user to input the path information of his/her folder.

This problem may be solved such that the path information of the folder for each user is automatically set using a user ID input by the user when the user logs in the image processing apparatus. This releases the user from inputting the path information of his/her folder for each transmission and selecting the path information of his/her folder from among a large amount of the path information registered in an address book.

In particular, when the path information is generated such that a user ID input by the user, which is common to a plurality of users, is added to a previously set common path, a folder of each user can be generated in a common hierarchy in the file server. This brings an advantage that it is easy for an administrator to perform management.

An environment that uses a domain controller (a domain server) for logging-in to the image processing apparatus is increasing. The domain controller is a server which manages account information of a specific domain in an integrated fashion. The use of the domain controller eliminates the need for managing the account information for each apparatus.

The domain controller includes two different types that requires including the domain information in the user ID used for authentication, and that does not require including the domain information in the user ID used for authentication (in other words, that requires the user ID which does not include the domain information). For example, if information inherent in the user is “userx” and domain information is “domainx”, “domainx\userx” needs to be input as the user ID when the former domain controller is used. If the latter domain controller is used, “userx” has only to be input as the user ID. A backslash “\” is a delimiter. Information come before the delimiter indicates domain information. Information come after the delimiter indicates information inherent in the user. In addition to the backslash “\,” “@” and “/” are also known as the delimiter.

Here, we consider a case where users authenticated by a first and a second domain controllers transmit the image data in a file using the same common path. If each domain controller is of the former type (that requires including the domain information in the user

ID used for authentication), the image data transmitted by each user is always stored in a different folder. As described above, this is because the user ID including the domain information needs to be input and is used as a part of the path information to distribute the image data to the folder corresponding to the domain information, if the domain controller of the former type is used.

On the other hand, if each domain controller is of the latter type (that does not require including the domain information in the user ID used for authentication), the domain information is not included in the input user ID, so that the domain information is not included in the path information either. Therefore, the transmitted image data is stored in the folder corresponding to the user ID (which does not include the domain information) lying immediately below the folder indicated by the common path. However, if users authenticated by the first and second domain controllers happen to use the same user ID, the respective image data transmitted by the two different users are resultantly stored in the same folder. In this case, the folder of the storage destination cannot be separated for each user, which is not user-friendly and may confuse the users.

### SUMMARY

Aspects of the present invention generally provide a mechanism which adds domain information to a user ID used for authenticating a user and sets such user ID as a part of path information of a folder to which image data is to be transmitted.

According to an aspect of the present invention, an image processing system includes a receiving unit configured to receive a user ID, a setting unit configured to add domain information to the user ID received by the receiving unit after a user is successfully authenticated based on the user ID received by the receiving unit and to set the domain information and the user ID as a part of path information of a folder to which image data is sent, and a transmission unit configured to transmit the image data to the folder indicated by the path information.

Further features of the present disclosure will become apparent from the following description of exemplary embodiments with reference to the attached drawings.

### BRIEF DESCRIPTION OF THE DRAWINGS

FIG. 1 is a general view of an image processing system according to the exemplary embodiment.

FIG. 2 is a block diagram illustrating a configuration of a MFP according to the exemplary embodiment.

FIG. 3 is a block diagram illustrating a configuration of an authentication server and a file server according to the exemplary embodiment.

FIGS. 4A and 4B illustrate operation screens of the MFP according to the exemplary embodiment.

FIG. 5 illustrates an operation screen of the MFP according to the exemplary embodiment.

FIG. 6 illustrates an operation screen of the MFP according to the exemplary embodiment.

FIG. 7 illustrates an operation screen of the MFP according to the exemplary embodiment.

FIGS. 8A and 8B illustrate operation screens of the MFP according to the exemplary embodiment.

FIG. 9 is a flowchart illustrating a log-in operation in the MFP according to the exemplary embodiment.

FIG. 10 is a flowchart illustrating a path information setting operation in the MFP according to the exemplary embodiment.

FIG. 11 is a diagram illustrating the operation screen of the MFP according to the exemplary embodiment.

FIG. 12 is a flowchart illustrating a transmission operation of the MFP according to the exemplary embodiment.

### DESCRIPTION OF THE EMBODIMENTS

Various exemplary embodiments will be described in detail below with reference to the drawings. It is to be understood that the following exemplary embodiment is not seen to be limiting, and not all of combinations of characteristics described in the exemplary embodiment are essential to the solutions for the present disclosure.

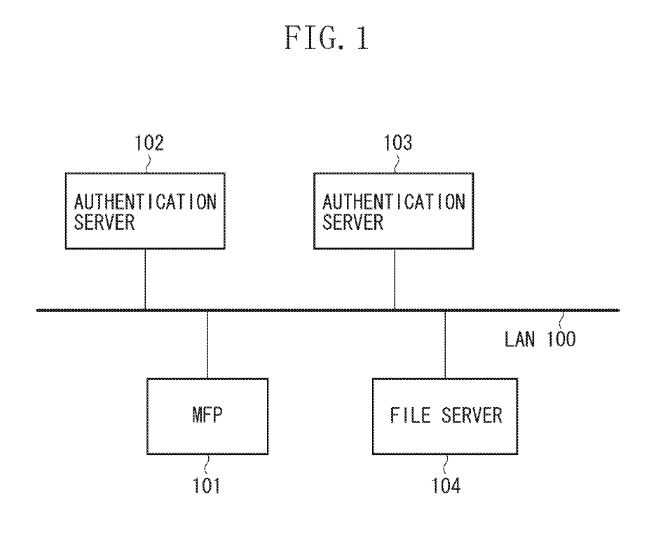

FIG. 1 is a general view of an image processing system. A MFP 101, authentication servers 102 and 103, and a file server 104 are communicably connected to one another via a local area network (LAN) 100. The MFP 101 is an example of an image processing apparatus. Although the MFP is described as an example of the image processing apparatus in the present exemplary embodiment, the example does not always have to be the MFP as long as it has a function to transmit image data such as, for example, a scanner device with a single function. The authentication servers 102 and 103 are examples of an authentication apparatus.

The file server 104 is an example of a file management apparatus. The MFP 101 can transmit a file of image data to a folder in the file server 104 using the SMB, the FTP, and the Web DAV. The MFP 101 can transmit image data as an electronic mail via a mail server (not illustrated).

The authentication servers 102 and 103 act as a domain controller. The authentication server 102 manages a domain of “Domain A” and the authentication server 103 manages a domain of “Domain B.” A user of the MFP 101 who logs in the “Domain A” is authenticated by the authentication server 102. A user of the MFP 101 who logs in the “Domain B” is authenticated by the authentication server 103.

The image processing system basically includes the MFP 101, the authentication servers 102 and 103, and the file server 104, however, the MFP 101 and the authentication servers 102 and 103 or only the MFP 101 may be referred to as the image processing system.

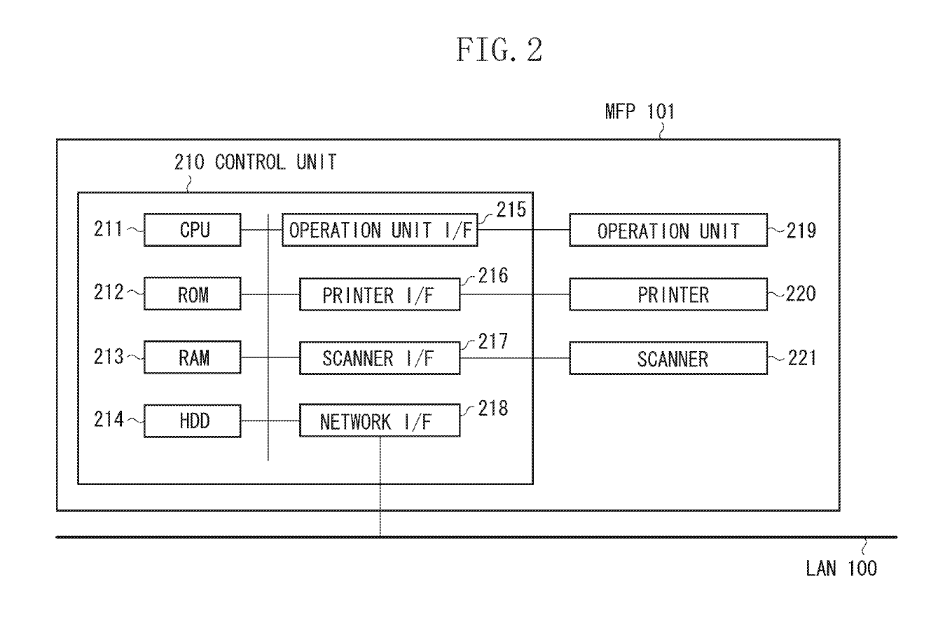

FIG. 2 is a block diagram illustrating a configuration of the MFP 101. A control unit 210 including a central processing unit (CPU) 211 controls an operation of the entire MFP 101. The CPU 211 reads a control program stored in a read only memory (ROM) 212 to perform various controls such as reading control and transmission control. A random access memory (RAM) 213 is used as a temporary storage area for a main memory and a work area of the CPU 211. Basically, in the MFP 101, one CPU 211 uses one memory (the RAM 213 or a hard disk drive (HDD) 214) to execute each processing of a flowchart described below, but, another configuration may be employed. For example, a plurality of CPUs and a plurality of RAMs or HDDs may be collaborated with each other to execute each processing indicated in the flowchart described below.

The HDD 214 stores image data and various programs. An operation-unit interface (I/F) 215 connects an operation unit 219 to the control unit 210. The operation unit 219 is equipped with a liquid crystal display with a touch panel function and a keyboard, and functions as a reception unit for receiving instructions from the user.

A printer I/F 216 connects a printer 220 to the control unit 210. Image data to be printed by the printer 220 is transferred from the control unit 210 via the printer I/F 216 to the printer 220 to be printed on a recording medium.

A scanner I/F 217 connects a scanner 221 to the control unit 210. The scanner I/F 217 reads images on a document to generate image data (an image file) and inputs the image data to the control unit 210 via the scanner I/F 217. The MFP 101 can transmit the image data (the image file) generated by the scanner 221 in a file or an electronic mail message.

A network I/F 218 connects the control unit 210 (MFP 101) to the LAN 100. The network I/F 218 transmits image data and information to external apparatuses (such as the authentication servers 102 and 103 and the file server 104) on the LAN 100 and receives various pieces of information from the external apparatuses on the LAN 100.

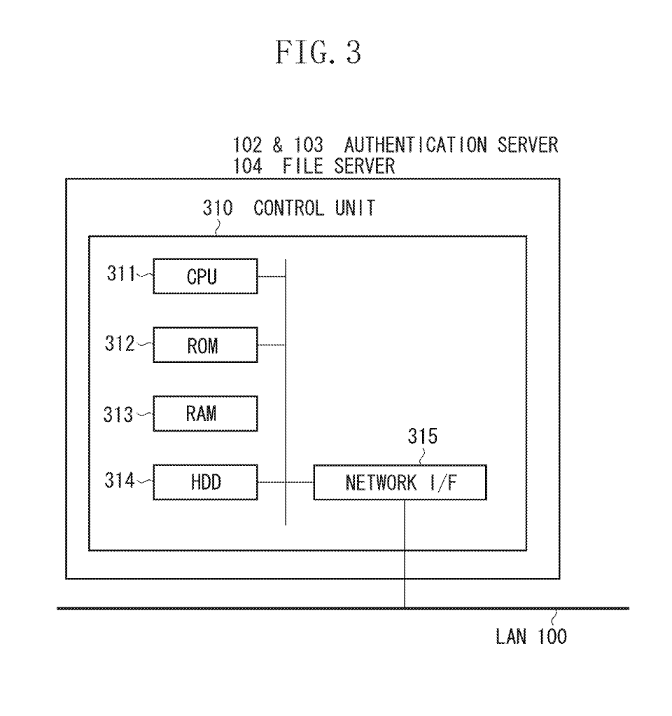

FIG. 3 is a block diagram illustrating a configuration of the authentication server 102. A control unit 310 including a CPU 311 controls an operation of the entire authentication server 102. The CPU 311 reads a control program stored in a ROM 312 to execute various control processing. A RAM 313 is used as a temporary storage area for a main memory and a work area of the CPU 311. Basically, in the authentication server 102, one CPU 311 uses one memory (the RAM 313 or a HDD 314) to execute each processing of a flowchart described below. However, another configuration may be employed. For example, a plurality of CPUs and a plurality of RAMs or HDDs may be collaborated with each other to execute each processing indicated in the flowchart described below.

The HDD 314 stores image data and various programs. A network I/F 315 connects the control unit 310 (the authentication server 102) to the LAN 100. The network I/F 315 transmits and receives various pieces of information with other apparatuses on the LAN 100. The authentication server 103 and the file server 104 are similar in configuration to the authentication server 102 in FIG. 3, so that the description thereof is omitted.

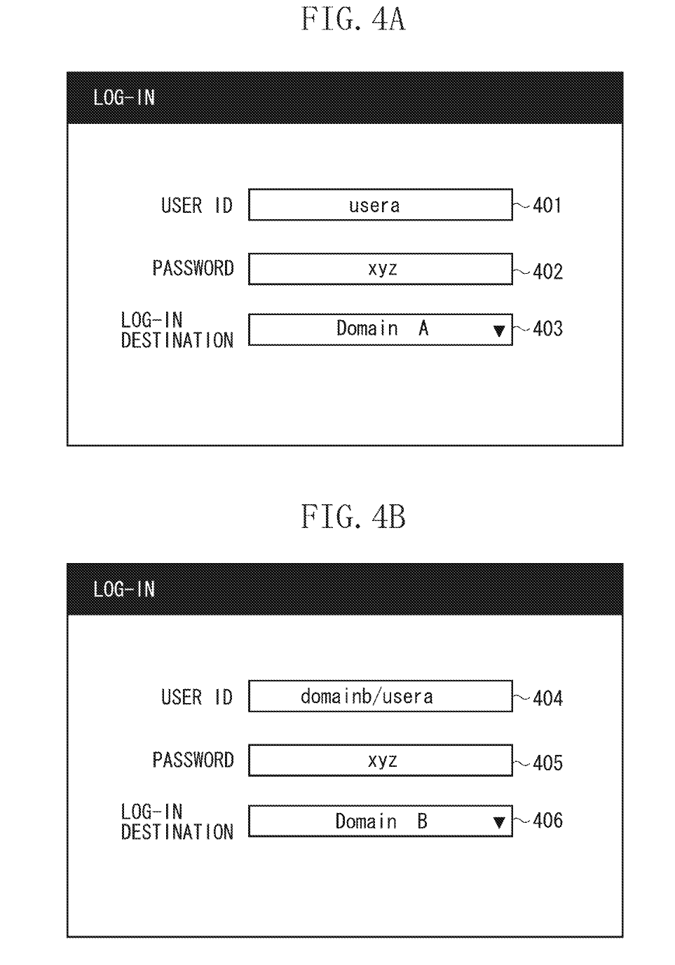

FIGS. 4A and 4B illustrate examples of an operation screen displayed on the operation unit 219. Before starting using the MFP 101, the user needs to input a user ID to an area 401 and a password to an area 402, respectively. The user needs to specify the domain to which the user logs in. More specifically, the user selects the domain to which the user logs in from options listed on a drop-down menu in an area 403. Herein, the “Domain A” managed by the authentication server 102 and the “Domain B” managed by the authentication server 103 are presented as options.

When the user instructs the MFP 101 to execute log-in in a state illustrated in FIG. 4A, the MFP 101 transmits “usera” and “xyz” to the authentication server 102 to request user authentication (inquires whether the user can use the MFP 101). Similarly, when the user instructs the MFP 101 to execute log-in in a state illustrated in FIG. 4B, the MFP 101 transmits “domainb\usera” and “xyz” to the authentication server 103 to request user authentication (inquires whether the user can use the MFP 101).

A comparison of the area 401 in FIG. 4A with the area 404 in FIG. 4B reveals that a character string of “domainb\” is added to the area 404. The “domainb” is domain information corresponding to “Domain B” managed by the authentication server 103. A backslash “\” is a delimiter. Information come before the delimiter indicates domain information. Information come after the delimiter indicates information inherent in the user. In addition to the slash “\,” “@” and “/” are also known as the delimiter.

The reason why the domain information is added to the area 404 is that the authentication server 103 is a domain controller which is of a type that requests to include the domain information in the user ID. On the other hand, the authentication server 102 is a domain controller which is of a type that does not request to include the domain information in the user ID, so that the domain information is not included in the area 401. Thus, the user needs to perform input while determining whether to include the domain information in the user ID according to the domain selected as a log-in destination.

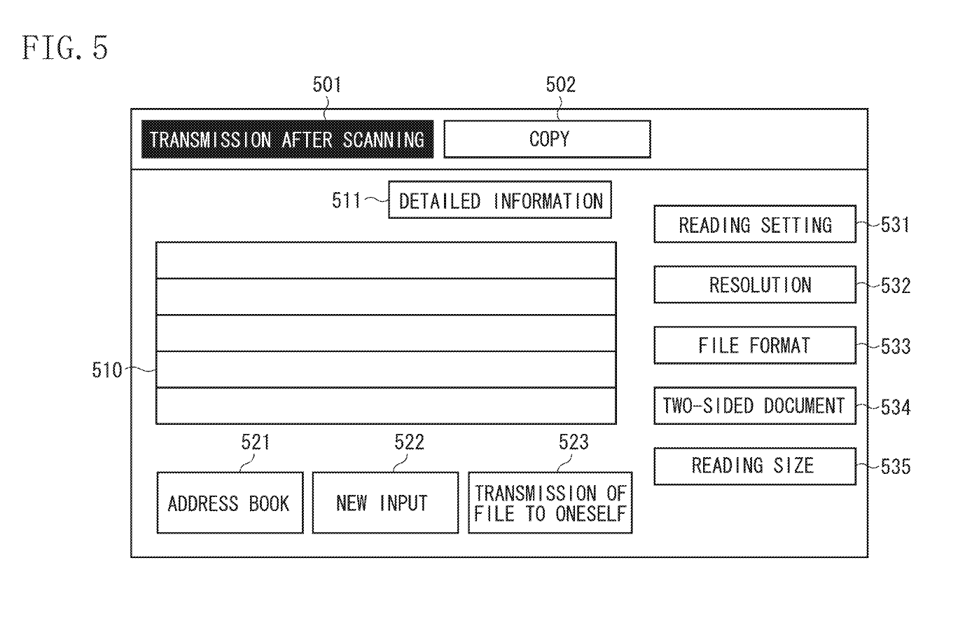

FIG. 5 illustrates an example of an operation screen displayed on the operation unit 219. In the screen in FIG. 5, the user operates a “transmission after scanning” key 501 or a “copy” key 502 to enable a function to be selected. FIG. 5 illustrates a state where the “transmission after scanning” key 501 is operated. Although FIG. 5 illustrates the “transmission after scanning” and the “copy” as a function, the MFP 101 may have other different functions.

The user who has operated the “transmission after scanning” key 501 can set a destination of the image data to be transmitted by operating any of the operation keys 521 to 523. The operation of an “address book” key 521 displays the contents of an address book stored in the HDD 214 to enable the user to set the destination of the image data with reference to the contents registered in the address book.

The operation of a “new input” key 522 displays a screen for receiving a new input from the user. The user inputs destination information via the displayed screen and can set the destination information as the destination of the image data.

A “transmission of file to oneself” key 523 is an operation key to be operated when the user wants to set a user's folder as the destination of the image data. The user operating the “transmission of file to oneself” key 523 automatically sets the path information about the user's folder as the destination of the image data (as described in detail below).

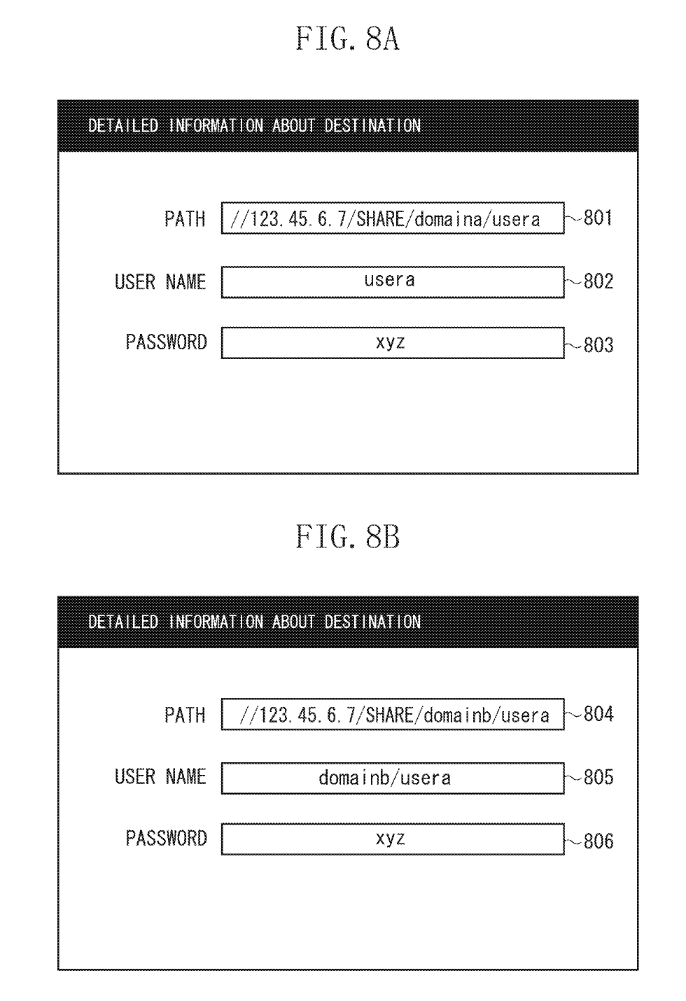

An area 510 displays the destination set using the operation keys 521 to 523. The operation of a “detailed information” key 511 with the destinations displayed in the area 510 one of which has been selected leads to display detailed information about the selected destination (FIGS. 8A and 8B).

A “reading setting” key 531 is an operation key used for reading setting such as color/monochrome. A “resolution” key 532 is an operation key used for setting reading resolution. A “file format” key 533 is an operation key used for setting the file format of image data to be transmitted. A “two-sided document” key 534 is an operation key used for setting one-sided/two-sided reading. A “reading size” key 535 is an operation key used for setting a reading size.

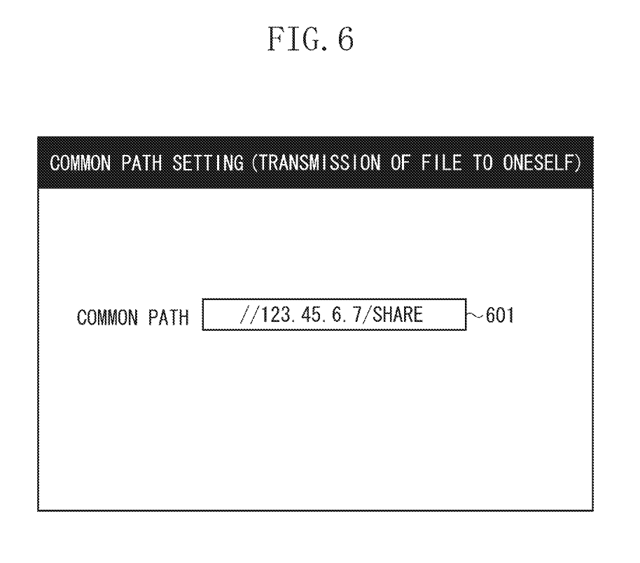

FIG. 6 is a diagram illustrating an example of an operation screen displayed on the operation unit 219. The screen in FIG. 6 can be operated only by an administrator and is not displayed when a general user operates the MFP 101. A common path commonly used among a plurality of users is input to an area 601. The common path set here is stored in the RAM 213, combined with the user ID input to the area 401 in FIG. 4A or the user ID input to the area 404 in FIG. 4B, and used as the path information of the folder to which the image data is stored.

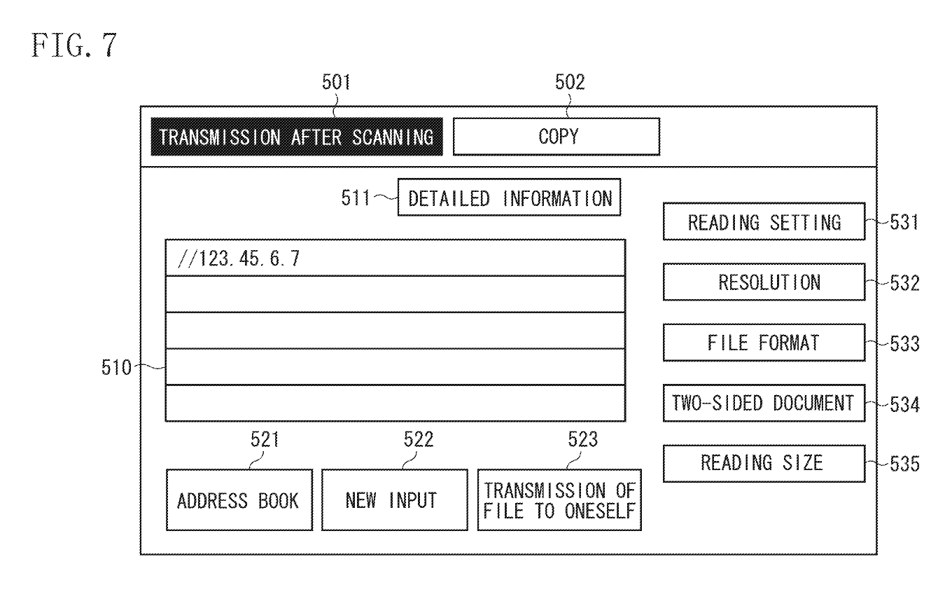

The user operating the “transmission of file to oneself” key 523 in FIG. 5 with the common path set as illustrated in FIG. 6 leads to shift the screen in FIG. 5 to the screen in FIG. 7. The screen in FIG. 7 displays a single destination of “\\123.45.6.7” in the area 510. The screen displays only a part corresponding to the host name of the file server 104 among the common paths set in the area 601 in FIG. 6. The operation of the “detailed information” key 511 with the “\\123.45.6.7” displayed in the area 510 which has been selected leads to display the screens in FIGS. 8A and 8B.

FIGS. 8A and 8B illustrate examples of an operation screen displayed on the operation unit 219. FIG. 8A illustrates an example where the user, who logs in in a state illustrated in FIG. 4A, operates the “transmission of file to oneself” key 523. An area 801 describes that a common path of “\\123.45.6.7\SHARE” follows the domain information of “domaina” added to the user ID of “usera” input in the area 401 in FIG. 4A. As a result, the image data is transmitted using the path information of “\\123.45.6.7\SHARE\domaina\usera.”

Thus, the reason why the path information is not set as “\\123.45.6.7\SHARE\usera” but the domain information of “domaina” is added to the user ID is to deal with the following problem. That is, if there exists an authentication server different from the authentication sever 102, but similar in type thereto (that does not require including the domain information in the user ID), another user may be managed using the same user ID as the “usera” managed in the authentication server 102. In such a case, if the image data is transmitted using the path information which does not include the domain information like the “\\123.45.6.7\SHARE\usera,” which causes a problem that the image data from a different user is stored in the same folder.

The MFP 101 is provided with a configuration for automatically adding the domain information in a case where the user ID which does not include the domain information is used as a part of the path information. Thereby, the image data is stored in a different folder by the added domain information even if the same user ID happens to be managed by a plurality of authentication servers.

The user ID of “usera” input to the area 401 in FIG. 4A is set as the user name of authentication information used for connection to the file server in the area 802 in FIG. 8A. Here, the domain information is not added to the user ID of “usera.” The password of “xyz” input to the area 402 in FIG. 4A is set as the password of authentication information used for connection to the file server in the area 803 in FIG. 8A.

FIG. 8B is an example in a case where the user logging in in a state illustrated in FIG. 4B operates the operation key 523. The path information of “\\123.45.6.7\SHARE\domainb\usera” in which the common path of “\\123.45.6.7\SHARE” and the “domainb\usera” input to the area 404 in FIG. 4B are combined is set in an area 804.

The user ID of the “domainb\usera” input to the area 404 in FIG. 4B is set as the user name of the authentication information used for connection to the file server in the area 805 in FIG. 8B. The password of “xyz” input to the area 405 in FIG. 4B is set as the password of the authentication information used for connection to the file server in the area 806 in FIG. 8B.

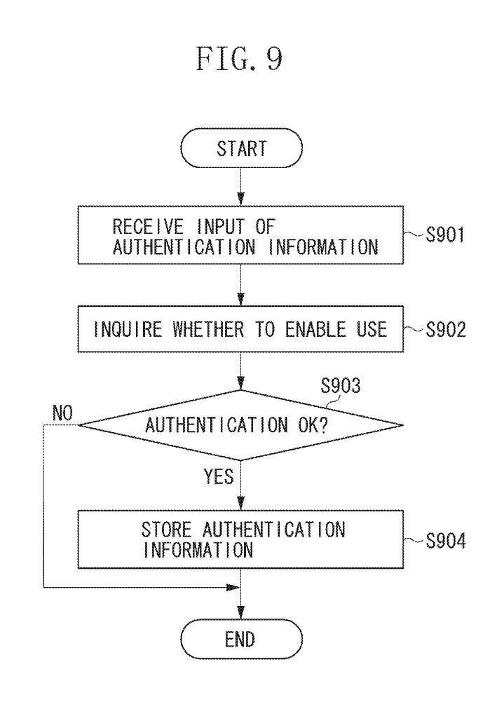

FIG. 9 is a flowchart illustrating a log-in operation (a series of operations at the time of the user starting to use the MFP 101) in the MFP 101. Each operation (step) illustrated in the flowchart of FIG. 9 is realized by the CPU 211 of the MFP 101 executing the control program stored in the HDD 214.

In step S901, the CPU 211 receives the user ID and the password input by the user via the screen (in FIG. 4) displayed on the operation unit 219.

In step S902, the CPU 211 transmits the user ID and the password received in step S901 to the authentication server 102 or 103 to request the server to authenticate the user (to inquire whether the user can use the MFP 101). The authentication server that receives the user ID and the password is switched according to the selection of a log-in destination using the area 403 in FIG. 4.

In step S903, the CPU 211 determines whether the contents of which the authentication server notifies the CPU 211 are authenticated as true or false. If the contents are authenticated as true (YES in step S903), the processing proceeds to step S904, and the CPU 211 allows the user to use each function of the MFP 101 and stores the user ID and the password received in step S901 in the RAM 213. If the contents are authenticated as false (NO in step S903), the processing ends (or returns to step S901 to display again the screen for receiving the user ID and the password).

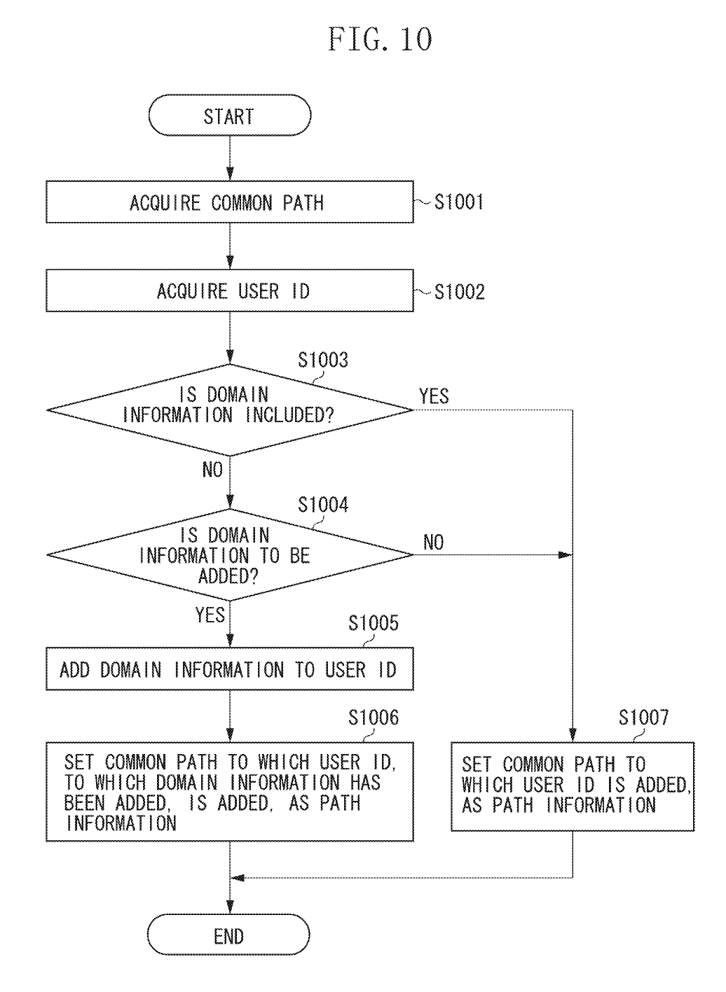

FIG. 10 is a flowchart illustrating a path information setting operation in the MFP 101. The user operating the “transmission of file to oneself” key 523 starts the flowchart in FIG. 10. Each operation (step) illustrated in the flowchart of FIG. 10 is realized by the CPU 211 of the MFP 101 executing the control program stored in the HDD 214.

In step S1001, the CPU 211 acquires the common path input into the area 601 in FIG. 6 and stored in the HDD 214. In step S1002, the CPU 211 acquires the user ID received in step S901 and stored in the RAM 213 in step S904.

In step S1003, the CPU 211 determines whether the domain information is included in the user ID acquired in step S1002 based on whether there exists a delimiter. More specifically, if a delimiter “\” is included in the user ID acquired in step S1002, the CPU 211 determines that the domain information is included (YES in step S1003) and the processing proceeds to step S1007. If the delimiter “\” is not included in the user ID acquired in step S1002, the CPU 211 determines that the domain information is not included (NO in step S1003) and the processing proceeds to step S1004.

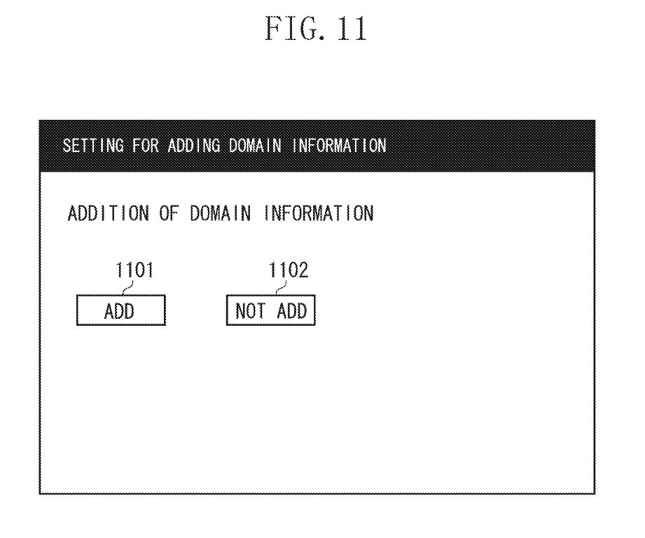

In step S1004, the CPU 211 determines whether the domain information is to be added to the user ID acquired in step S1002. Whether the domain information is to be added to the user ID is previously set by an administrator via a screen in FIG. 11.

FIG. 11 is a diagram illustrating an example of the operation screen displayed on the operation unit 219. The screen in FIG. 11 can be operated only by an administrator and is not displayed when a general user operates the MFP 101. If the administrator operates an “add” key 1101 on the screen in FIG. 11, it should be selected that the domain information is added to the user ID.

If the administrator operates a “not add” key 1102, it should be selected that the domain information is not added to the user ID. In this case, even if the domain information is not included in the user ID, the user ID which does not include the domain information is set as a part of the path information without adding the domain information thereto. For example, if only one domain (authentication server) exists in the system or if environment is managed so that the same user ID cannot be duplicated in a plurality of domains, a problem that the image data of a different user is stored in the same folder does not occur. Notwithstanding, the addition of the domain information leads to store the image data in a folder deeper by one hierarchy than required, which impairs usability. In such a case, it is advisable not to set addition of the domain information.

If the addition of the domain information to the user ID is selected (YES in step S1004), the CPU 211 determines that the domain information is added thereto and the processing proceeds to step S1005. If the addition of the domain information to the user ID is not selected (NO in step S1004), the CPU 211 determines that the domain information is not added thereto and the processing proceeds to step S1007.

In step S1005, the CPU 211 adds the domain information to the user ID acquired in step S1002. The HDD 214 of the MFP 101 stores the domain information to be added to the user ID associated with each of a plurality of domains (the authentication server) which can be selected in the area 403 in FIG. 4. In step S1005, the CPU 211 reads and uses the domain information stored in the HDD 214.

In step S1006, the CPU 211 adds the user ID, to which the domain information has been added, after the common path part and sets them as the path information of the folder. On the other hand, in step S1007, the CPU 211 adds the user ID which does not include the domain information after the common path, and sets them as the path information of the folder. If the determination of step S1004 is not performed and the domain information is not included in the user ID, the domain information may always be added.

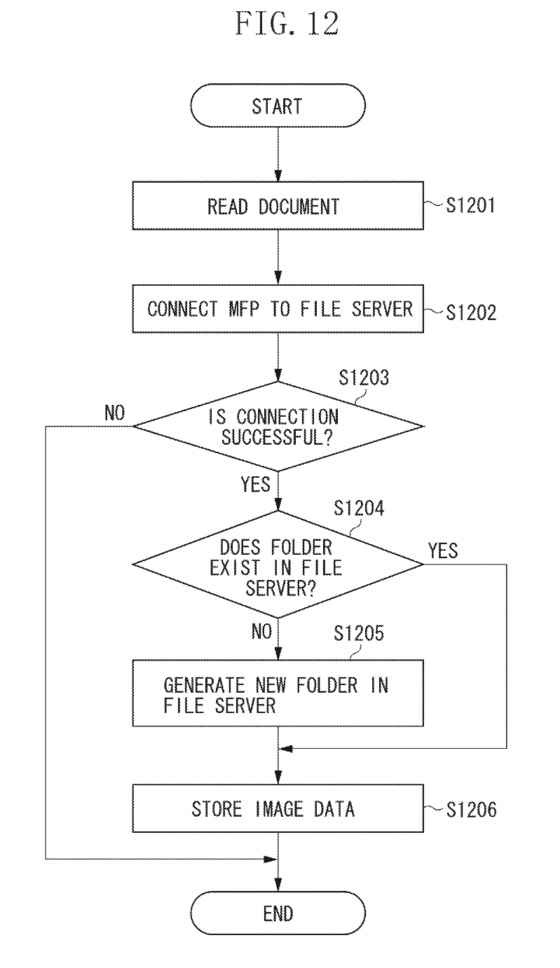

FIG. 12 is a flowchart illustrating a transmission operation in the MFP 101. The user setting the destination of the image data and operating a start key (not illustrated) starts the flowchart in FIG. 12. Each operation (step) illustrated in the flowchart of FIG. 12 is realized by the CPU 211 of the MFP 101 executing the control program stored in the HDD 214.

In step S1201, the scanner 221 reads the image on a document to generate image data. In step S1202, the MFP 101 is connected to the file server 104 according to the path information set in step S1006 or S1007 in FIG. 10. At this point, the user name and the password displayed on the screen in FIG. 8 are used for log-in to the file server 104.

In step S1203, the CPU 211 determines whether the MFP 101 succeeds in connection with the file server 104. If the MFP 101 succeeds in connection with the file server 104 (YES in step S1203), the processing proceeds to step S1204. If the MFP 101 does not succeed (NO in step S1203), the processing ends.

In step S1204, the CPU 211 determines whether the folder indicated by the path information set in step S1006 or S1007 in FIG. 10 exists in the file server 104. If the folder exists therein (YES in step S1204), the processing proceeds to step S1206. If the folder does not exist (NO in step S1204), the processing proceeds to step S1205.

In step S1205, the folder indicated by the path information set in step S1006 or S1007 in FIG. 10 is newly generated in the file server 104. More specifically, a command for requesting the file server 104 to generate a new folder is transmitted thereto. If the folder indicated by the path information set in step S1006 or S1007 in FIG. 10 does not exist in the file server 104 (NO in step S1204), the processing may end as an error termination.

In step S1206, the CPU 211 transmits the image data to the file server 104, and stores the image data in the folder indicated by the path information set in step S1006 or S1007 in FIG. 10.

The above processing allows the path including the domain information to be simply set as the destination of the image data even if the domain information is not included in the user ID.

In the above example, the user is authenticated according to the flowchart in FIG. 9 when the user starts to use the MFP 101. However, another situation may be employed. For example, the user selects a specific function and then a user authentication for using the function may be performed according to the flowchart in FIG. 9.

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these embodiments are not seen to be limiting. The scope of the following claims is to be accorded the broadest interpretation so as to encompass all such modifications and equivalent structures and functions.

This application claims the benefit of Japanese Patent Application No. 2013-087888 filed Apr. 18, 2013, which is hereby incorporated by reference herein in its entirety.

What is claimed is:

1. An image processing system comprising:
a receiving unit configured to receive a user ID;
a setting unit configured to add domain information to the user ID received by the receiving unit after a user is successfully authenticated based on the user ID received by the receiving unit and to set the domain information and the user ID as a part of path information of a folder to which image data is sent; and
a transmission unit configured to transmit the image data to the folder indicated by the path information.

2. The image processing system according to claim 1, further comprising a determination unit configured to determine whether the domain information is included in the user ID received by the receiving unit,
wherein, as a result of the determination made by the determination unit, if it is determined that the domain information is not included in the user ID received by the receiving unit, the setting unit adds the domain information to the user ID received by the receiving unit.

3. The image processing system according to claim 2, wherein the determination unit makes a determination based on whether a delimiter exists.

4. The image processing system according to claim 2, further comprising a selection unit configured to select whether to add the domain information to the user ID received by the receiving unit,
wherein, as a result of the determination made by the determination unit, if it is determined that the domain information is not included in the user ID received by the receiving unit, the setting unit adds the domain information to the user ID received by the receiving unit and sets the domain information and the user ID as a part of the path information when addition of the domain information to the user ID received by the receiving unit is selected, and the setting unit does not add the domain information to the user ID received by the receiving unit and sets the user ID as a part of the path information when non-addition of the domain information to the user ID received by the receiving unit is selected.

5. The image processing system according to claim 1, wherein the path information includes a common path part commonly used among a plurality of users.

6. The image processing system according to claim 1, further comprising an operation key configured to instruct setting of an authenticated user's folder as a destination of the image data,
wherein the setting unit performs the setting in response to an operation of the operation key.

7. The image processing system according to claim 1, further comprising a designating unit configured to designate a domain of a log-in destination,
wherein the setting unit adds the domain information corresponding to the domain designated by the designating unit to the user ID received by the receiving unit.

8. The image processing system according to claim 7, further comprising a storage unit configured to store the domain information for each domain designated by the designating unit.

9. The image processing system according to claim 1, further comprising a reading unit configured to read an image on a document to generate image data,
wherein the transmission unit transmits the image data generated by the reading unit.

10. An image processing method comprising:
receiving a user ID;
adding domain information to the received user ID after a user is successfully authenticated based on the received user ID and setting the domain information and the user ID as a part of path information of a folder to which image data is sent; and
transmitting the image data to the folder indicated by the path information.

11. A non-transitory computer readable storage medium storing computer executable instructions for causing a computer to execute a method, the method comprising:
receiving a user ID;
adding domain information to the received user ID after a user is successfully authenticated based on the received user ID and setting the domain information and the user ID as a part of path information of a folder to which image data is sent; and
transmitting the image data to the folder indicated by the path information.
